(19) United States
(12) Patent Application Publication
(10) Pub. No.: US 2018/0022014 A1
(43) Pub. Date: Jan. 25, 2018

(54) METHOD FOR PRODUCING OPTICAL FILM, AND OPTICAL FILM

(71) Applicant: Kaneka Corporation, Osaka (JP)

(72) Inventor: Naoya Kamikariya, Osaka (JP)

(73) Assignee: Kaneka Corporation, Osaka (JP)

(21) Appl. No.: 15/720,610

(22) Filed: Sep. 29, 2017

Related U.S. Application Data
(63) Continuation of application No. PCT/JP2016/060164, filed on Mar. 29, 2016.

(30) Foreign Application Priority Data
Mar. 30, 2015 (JP) 2015-070350

(51) Int. Cl. B29C 55/00; G02B 1/08; G02B 5/30

(52) U.S. Cl. CPC B29C 55/005; G02B 5/3083; G02B 1/08; B82Y 20/00

(57) ABSTRACT

A method for producing an optical film includes forming a stretched film by stretching a thermoplastic resin composition comprising a thermoplastic resin and rubber particles at a stretching temperature; and heating the stretched film at a heat treatment temperature while applying a tensile force in a stretching direction of the stretched film. The stretched film is a biaxially stretched film. The stretching temperature is from Tg to (Tg+20° C.), provided that Tg is a glass transition temperature of the stretched film. The heating reduces a size of the stretched film in the stretching direction by simultaneously decreasing a longitudinal size and a width size of the stretched film, and the heat treatment temperature is from (Tg+10° C.) to (Tg+23° C.)

### TECHNICAL FIELD

One or more embodiments of the present invention relate to a method for producing an optical film and an optical film.

### BACKGROUND

An optical film typified by a polarizer protective film for protecting a polarizer, a film substrate for a liquid crystal display, or the like is required to have optical transparency and optical homogeneity. In particular, regarding the polarizer protective film, in order to improve brightness, a film thickness to be desired is gradually decreased, and for production of such a thin polarizer protective film, a production method in which a melt-extruded film is biaxially stretched is known (Patent Document 1: Japanese Unexamined Patent Application, Publication No. 2010-95567). Further, as the thickness of the film is decreased, cracks at the time of handling the film, or the like may be caused even after the biaxial stretching. Thus, a demand for providing strength to the film is also further increasing. As an existing method of providing strength, for example, a method in which rubber particles are added to a brittle thermoplastic resin to obtain a melt-extruded film with excellent bending resistance is known (Patent Document 2: Japanese Unexamined Patent Application, Publication No. 2004-137299).

Patent Document 1: Japanese Unexamined Patent Application, Publication No. 2010-95567

### Patent Document 2: Japanese Unexamined Patent Application, Publication No. 2004-137299

In order to obtain a desired high-strength thin film, a method of biaxially stretching a melt-extruded film mixed with rubber particles by combining the above-described background arts (hereinafter, this film before a stretching treatment is called an original film) is considered.

However, it has been found from the studies of the present inventor that when an original film mixed with rubber particles is biaxially stretched, it is possible to provide strength to the film but the film is significantly whitened. As studies have been conducted in more detail, it has been specified that when a film mixed with rubber particles is biaxially stretched, the rubber particles present in the vicinity of the film surface protrude from the film surface and the surface roughness accordingly deteriorates so that incident light is scattered, which results in whitening of the film. In addition, in the case of biaxial stretching of the film, although a bending strength in a film planar direction is increased, the film becomes brittle in a film thickness direction, and thus it is difficult to sufficiently increase strength with respect to film punching necessary for higher processing of the film, even by mixing rubber.

### SUMMARY

One or more embodiments of the present invention provide a production method by which a high-strength thin optical film where burr at end surfaces of the film at the time of cutting the film is less likely to occur can be obtained while whitening caused by rubber particles is suppressed when a melt-extruded film containing rubber particles is produced as a stretched film, and an optical film.

The present inventor has conducted intensive studies, and has found that regarding the phenomenon of protruding of the rubber particles from the surface occurring at the time of stretching, the rubber particles on the surface are buried by reducing a size of a biaxially stretched film to a stretching direction while a tensile force is applied to the biaxially stretched film at a specific stretching temperature, more specifically, by performing a heat treatment at a specific heat treatment temperature after biaxial stretching to simultaneously decrease the sizes in the longitudinal and width directions of the biaxially stretched film. In addition, the present inventor has found that the strength in the thickness direction is also increased by specifying heat treatment conditions in the heat treatment. At this time, although the strength in the stretching direction is lowered as compared with that before the heat treatment, strain in the stretching direction applied to the rubber particles is relaxed by simultaneously decreasing the sizes in the longitudinal and width directions of the biaxially stretched film so that the shapes of the rubber particles return to a spherical shape, and thus the effect of mixing rubber is significantly exhibited. As a result, it has been found that the strength is exhibited to a practically sufficient level over a two-dimensional direction of the stretching direction and the thickness direction or three-dimensional direction.

That is, one or more embodiments of the present invention provide the following.
(i) A method for producing an optical film, including a relaxation step of reducing a size of a stretched film to a stretching direction while applying a tensile force to the stretching direction of the stretched film, the stretched film being formed from a thermoplastic resin composition containing a thermoplastic resin and rubber particles, wherein the stretching is biaxial stretching; a stretching temperature is Tg or higher but Tg+20° C. or lower, provided that Tg is a glass transition temperature of the stretched film; in the relaxation step, the reducing the size of the stretched film is performed by simultaneously decreasing the sizes in the longitudinal and width directions of the stretched film; and the relaxation step is performed by carrying out a heat treatment to the stretched film and a heat treatment temperature of the heat treatment is Tg+10° C. or higher but Tg +23° C. or lower.
(ii) The method for producing an optical film described in (i), in which a stretching ratio of the stretching is 1.5 to 3.0 times.
(iii) The method for producing an optical film described in (i) or (ii), in which when a size of the stretched film in the stretching direction before the relaxation step is regarded as D0 and a size of the stretched film in the stretching direction after the relaxation step is regarded as D1, a size reduction ratio represented by a formula: (D0−D1)/D0×100 is 0.1 to 25%.
(iv) The method for producing an optical film described in any one of (i) to (iii), in which a temperature of the stretched film is maintained to be Tg or higher at least during a period from the stretching of the stretched film to the completion of the relaxation step.
(v) The method for producing an optical film described in any one of (i) to (iv), in which a radiation heating device is used in the heat treatment.
(vi) The method for producing an optical film described in any one of (i) to (v), in which the thermoplastic resin contains an acrylic resin.
(vii) The method for producing an optical film described in any one of (i) to (vi), in which the thermoplastic resin contains an acrylic resin having a glass transition temperature of 110° C. or higher.
(viii) The method for producing an optical film described in any one of (i) to (vii), in which the thermoplastic resin contains at least one selected from the group consisting of an acrylic resin copolymerized with an N-substituted maleimide compound as a copolymerization component, a glutaric anhydride acrylic resin, an acrylic resin having a lactone ring structure, a glutarimide acrylic resin, an acrylic resin containing a hydroxyl group and/or a carboxyl group, an aromatic vinyl-containing polymer obtained by polymerization of an aromatic vinyl monomer and another monomer copolymerizable therewith or a hydrogenated aromatic vinyl-containing polymer obtained by partial or complete hydrogenation of aromatic rings thereof, and an acrylic polymer containing a cyclic acid anhydride repeating unit.
(ix) The method for producing an optical film described in any one of (i) to (viii), in which an orientation birefringence of the optical film is from −1.7×10⁻⁴ to 1.7×10⁻⁴.
(x) The method for producing an optical film described in any one of (i) to (ix), in which a photoelastic constant of the optical film is from −10×10 ⁻¹² to 4×10⁻¹²Pa ⁻¹.
(xi) An optical film being formed from a thermoplastic resin composition containing a thermoplastic resin and rubber particles and being stretched, in which a ratio of MIT of the optical film in a flow direction to MIT of the optical film in a width direction is in a range of 0.7 to 1.3, MIT of the optical film in both the flow direction and the width direction is 1,000 times or more, provided that MIT is the number of bendings at breakage as measured according to JIS C 5016, a haze of the optical film as measured according to JIS K 7105 is 1.0% or less, and in a stamping test where the optical film is punched in a dumbbell shape by using a punching machine and a circumference of the dumbbell is observed with an optical microscope, burr at end surfaces of the dumbbell is not observed.
(xii) An optical film being formed from a thermoplastic resin composition containing a thermoplastic resin and rubber particles and being stretched, in which an average surface roughness Ra of both surfaces of the optical film at a 5 μm viewing angle is 0.1 nm or more but 4 nm or less, and a difference in average surface roughness between both the surfaces is 2.0 nm or less.
(xiii) The optical film described in (xii), in which, in a stamping test where the optical film is punched in a dumbbell shape by using a punching machine and a circumference of the dumbbell is observed with an optical microscope, burr at end surfaces of the dumbbell is not observed.
(xiv) The optical film described in any one of (xi) to (xiii), in which the stretching is biaxial stretching.
(xv) The optical film described in any one of (xi) to (xiv), in which a haze as measured according to JIS K 7105 is 1.0% or less.
(xvi) The optical film described in any one of (xi) to (xv), in which a ratio of MIT of the optical film in a flow direction to MIT of the optical film in a width direction is in a range of 0.7 to 1.3, and MIT of the optical film in both the flow direction and the width direction is 1,000 times or more, provided that MIT is the number of bendings at breakage as measured according to JIS C 5016.
(xvii) The optical film described in any one of (xi) to (xvi), in which the thermoplastic resin is an acrylic resin.
(xviii) The optical film described in any one of (xi) to (xvii), in which an average film thickness is 15 to 60 μm.

According to one or more embodiments of the present invention, it is possible to provide a method for producing an optical film, the method capable of suppressing the whitening of the film after stretching by using a thermoplastic resin composition containing rubber particles. According to one or more embodiments of the production method, it is possible to produce a thin optical film, which has high transparency and has a high strength in a two-dimensional or three-dimensional direction, where burr at end surfaces of the film at the time of cutting the film is less likely to occur, from a thermoplastic resin composition containing rubber particles.

### DETAILED DESCRIPTION OF THE EMBODIMENTS

One or more embodiments of the present invention relate to a method for producing an optical film using a thermoplastic resin composition, and an optical film is produced by stretching an original film obtained by a melt film formation method, specifically, by continuously or discontinuously biaxially stretching an original film. In the melt film formation method, a thermoplastic resin is melted by heating using a melting means such as an extruder and then is supplied to a die, the molten resin discharged from the die in a film form is casted by a temperature-adjusted roll (hereinafter, referred to as a cast roll) and is further brought into contact with another temperature-adjusted roll (hereinafter, referred to as a cooling roll) while being taken up so as to be cooled and solidified. It is characterized in that at this time, insertion molding is performed in which a temperature-adjusted roll (hereinafter, referred to as a touch roll) is pressed to the vicinity of the position of the cast roll at which the film is landed. In this case, the position of the roll at which the film is landed is stable to improve the thickness quality and the cooling in the film width direction is also uniform. Thus, the orientation state at the time of cooling and solidification is also uniform.

Further, various methods can be employed for taking up the film, and for example, the film is taken up by a nip roll provided at the subsequent stage of the cooling roll and then is wound around a winding core so that the film is obtained as an original film. At this time, since both end portions of the film are increased in a thickness due to the influence of neck-in occurring when the resin is discharged from a T-die, in a case where thick end portions influence a thickness profile after biaxial stretching, the end portions may be trimmed by various cutters (for example, a shear blade, a razor blade, and the like). The thickness profile in the width direction of the original film obtained in this way can be arbitrarily set to an optimal value according to a biaxial stretching scheme and conditions, and for example, in the width direction, the film is formed to be flat or the both ends are formed to be higher or lower than the center of the film.

The original film obtained in this way is stretched to have a desired product thickness and to provide a desired strength. Specifically, the film is stretched in the biaxial direction by biaxial stretching. Consequently, strength can be improved in a three-dimensional direction. A stretching ratio may be set to 1.5 times or more but 3.0 times or less in both the longitudinal direction and the transverse direction. When the stretching ratio is 3.0 times or less, a haze is easily reduced by one or more embodiments of the present invention and the film is less likely to be whitened. In addition, when the stretching ratio is 1.5 times or more, it is easy to sufficiently maintain planar strength by orientation relaxation in a relaxation step performed by carrying out a heat treatment to the stretched film. The stretching ratio may be 1.6 times or more but 2.8 times or less. A stretching temperature may be set to a range from a glass transition temperature (Tg) of the stretched film to Tg+20° C. or to a range from Tg+3° C. to Tg+10° C.

In one or more embodiments of the present invention, according to the optical film production method including a relaxation step to be described below, it is possible to relax surface unevenness occurring due to protruding of the rubber particles at the time of stretching to reduce a haze. In addition, although the orientation of the thermoplastic molecular chain in the planar direction is relaxed, the deformation of the rubber particles is relaxed (the shapes of the rubber particles return to a spherical shape) and the degree of exhibiting strength obtained by mixing rubber becomes dominant. Thus, it is possible to sufficiently exhibit strength in both the planar direction and the thickness direction. More microscopically, as a result of stretching, since the stretched film tends to have a larger film thickness at a position where the rubber particles are present and a smaller film thickness at a position where the rubber particles are not present, a sea-island structure in which the position where the rubber particles are present is regarded as an island and the position where the rubber particles are not present is regarded as a sea is formed at both surfaces of the stretched film. When the relaxation step is carried out to such a stretched film, the film thickness of the sea portion is increased, a difference between the film thickness of the sea portion and the film thickness of the island portion becomes smaller, and thus unevenness on the stretched film surface becomes moderate to reduce a haze.

In the relaxation step, the size of the stretched film is reduced to the stretching direction while a tensile force is applied to the stretching direction of the stretched film formed from a thermoplastic resin composition containing a thermoplastic resin and rubber particles. By reducing the size of the stretched film in this way, the molecular chain orientation to the thickness direction occurs, and thus the strength in the thickness direction can be increased. Reducing of the size of the stretched film can be performed by simultaneously decreasing the sizes in the longitudinal and width directions of the stretched film, specifically, by simultaneously decreasing both a distance in the longitudinal direction between clips and a distance in the width direction between clips.

Since the molecular chain orientation to the thickness direction easily occurs and the strength in the thickness direction is easily improved, the size reduction ratio represented by a formula: (D0−D1)/D0×100 may be 0.1 to 25% or 0.5 to 20%. Herein, D0 indicates a size of the stretched film in the stretching direction before the relaxation step, and D1 indicates a size of the stretched film in the stretching direction after the relaxation step. Incidentally, D0 and D1 are sizes of regions corresponding to each other on the stretched film before and after the relaxation step.

As described above, a sea-island structure is formed on both surfaces of the stretched film. From the viewpoint of haze reduction, strength, or the like, a difference between the thickness of the island portion and the thickness of the sea portion is more than 30 nm before the relaxation step; on the other hand, a difference therebetween may be 1 to 30 nm after the relaxation step. The difference can be calculated from the result obtained by observing the surface of the stretched film with a scanning probe microscope (SPM) and measuring the height from the sea portion to the apex of the island.

The rubber particles in the stretched film show a flat shape such as an ellipsoid by biaxial stretching. Particularly, when seen from the direction perpendicular to the cross-section of the stretched film, the rubber particles show an elliptical shape having a major axis in the planar direction of the stretched film and a minor axis in the thickness direction of the stretched film. That is, the rubber particles have a long diameter and a short diameter on the cross-section of the stretched film. In the cross-section of the stretched film, a ratio of the long diameter and the short diameter of the rubber particles may be, before the relaxation step, more than 4.0, 4.2 or more but 20.0 or less, 4.5 or more but 15.0 or less, 4.8 or more but 12.0 or less, or 5.0 or more but 10.0 or less, and may be, after the relaxation step, 4.0 or less, 3.0 or less, 2.0 or less, 1.5 or less, or 1.1 or less. When the ratios before and after the relaxation step are within such a range, a balance between the stretching and the relaxing is easily maintained and an optical film having a sufficient strength is easily obtained while a haze is reduced. The ratio can be calculated from the result obtained by observing the cross-section of the stretched film with a transmission electron microscope (TEM) and measuring the long diameter and the short diameter of the rubber particles.

From the viewpoint that the molecular chain orientation to the thickness direction easily occurs and the strength in the thickness direction is easily improved, the ratio of the average film thickness of the stretched film after the relaxation step to the average film thickness of the stretched film before the relaxation step (film thickness increase rate) may be 1.0 to 1.8 or 1.0 to 1.6.

In one or more embodiments, the relaxation step is performed by carrying out a heat treatment to the stretched film, and the heat treatment temperature of the heat treatment is Tg+10° C. or higher but Tg+23° C. or lower. Here, Tg is the glass transition temperature of the stretched film. When the heat treatment temperature is Tg+10° C. or higher, surface deformation generated in the stretching step is easily relaxed so that the haze is easily reduced and flat deformation of the rubber particles is also easily relaxed. When the heat treatment temperature is Tg+23° C. or lower, the film is less likely to drip off in a furnace so that there is low possibility that the film cannot be conveyed. Further, the orientation relaxation is less likely to increase and a large decrease in planar strength is easily prevented. This heat treatment can be performed in a state where the film after stretching is conveyed in the zone in the oven adjusted, for example, to a temperature equal to or higher than Tg+10° C. without performing an increase operation of a distance between gripping portions.

The heat treatment time in the heat treatment zone may be 0.5 times or more but 1.5 times or less the stretching treatment time in the stretching treatment zone. When the heat treatment time is 0.5 times or more the stretching treatment time, the heat treatment time is sufficiently taken so that the film easily reaches the heat treatment temperature uniformly, and strength unevenness according to orientation unevenness is less likely to occur. Incidentally, in a case where conveyance speeds of the film between the heat treatment zone and the stretching treatment zone are same as each other, by setting the distance of the heat treatment zone to 0.5 times or more but 1.5 times or less the distance of the stretching treatment zone, the heat treatment time in the heat treatment zone can be set to 0.5 times or more but 1.5 times or less the stretching treatment time in the stretching treatment zone. In addition, in the heat treatment zone, the sizes in the longitudinal and width directions of the stretched film, specifically, the distances in both the longitudinal direction and the width direction between clips may be simultaneously decreased to a range of 0.1% or more but 25% or less, or a range of 0.5% or more but 20% or less. By decreasing the distance in this way while the heat treatment is performed, the molecular chain orientation to the thickness direction occurs, and thus the strength in the thickness direction can be increased. Here, as a result of carrying out simultaneous biaxial relaxation, the thickness is increased according to the degree of the simultaneous biaxial relaxation, but by increasing the stretching ratio to correct this increase, a stretched film having a desired thickness can be obtained.

Further, as a heating means in the heat treatment zone, similarly to the stretching zone, a hot air treatment or the like can be also employed. However, since an increase in the width direction is not carried out, a tensile force in the furnace is insufficient and the film is fanned by hot air so that the film may be brought into contact with a supply nozzle for hot air in the furnace to be broken or unevenness of the film thickness may occur. However, when the blower air flow rate is decreased, heating efficiency is also decreased. Thus, in a case where the heat treatment temperature is increased to a temperature higher than the stretching temperature, there is a concern that the whole film does not reach a desired heat treatment temperature. Therefore, in the heat treatment zone, it may be possible to provide an auxiliary heating means in the furnace, and from the viewpoint of heating efficiency, it may be possible to use a radiation heating device such as an infrared heater.

The biaxial stretching in one or more embodiments of the present invention may be successive biaxial stretching or simultaneous biaxial stretching, but simultaneous biaxial stretching that is better in terms of strength isotropy may be used. Further, an original film obtained by a melt extrusion method may be continuously treated or the original film may be treated by winding the original film around a roll and then feeding the wound roll, but it may be possible that the film is continuously treated from the viewpoint of productivity. As the successive biaxial stretching, longitudinal stretching in which a film is stretched in the longitudinal direction (film flow direction) and stretching in the transverse direction (film width direction) may be carried out in this order. As a longitudinal stretching scheme, various schemes, such as a roll stretching scheme in which a film is plasticized using two or more heating rolls each equipped with a nip roll and then is stretched at a difference in roll circumferential velocity and a zone stretching scheme in which a film is plasticized in a heating oven and then stretched using a roll equipped with a nip roll at a difference in circumferential velocity thereof before and after the oven, can be used. As a transverse stretching scheme, various schemes, such as a scheme in which both end portions of a film are gripped by clips or pins and the film is plasticized in an oven and then is stretched by increasing a distance between both ends of gripping portions to the width direction in the oven, can be used. In the transverse stretching, since there are the gripping portions, gripping trace caused by the gripping portions remains so that the resultant film is not suitable as a product. Thus, it may be possible to slit the both ends. For the slit, various cutters (for example, a shear blade, a razor blade, and the like) can be used, but from the viewpoint of continuous moldability, a shear blade may be used. As a simultaneous biaxial stretching scheme, a scheme having a mechanism in which a film is plasticized in an oven and is stretched by increasing a distance between gripping portions to the transverse direction in the oven and a gap in the longitudinal direction between the gripping portions is increased can be used in the clip tenter. In the case of stretching a thermoplastic resin mixed with rubber particles, the molecule chain of the thermoplastic resin is oriented to the biaxial direction by biaxial stretching and the rubber particles are deformed in the biaxial direction to be in a flat state. Although the strength in the biaxial direction of the molecular chain is increased, when the solidification is carried out in a state where the rubber particles are deformed, the strength is not sufficiently expressed, and particularly, the strength in the thickness direction is in a weak state.

Therefore, before solidification by cooling after biaxial stretching in this way, the heat treatment step may be performed after the stretching treatment in a transverse stretching device in the case of successive biaxial stretching, and in a simultaneous biaxial stretching device in the case of simultaneous biaxial stretching. In a case where the heat treatment step is independently provided after the stretching step, the cooled film is heated at a temperature higher than the glass transition temperature again and then cooled so that energy efficiency is poor and a space for production is increased by an increase in length of installation. From the above description, it may be possible to maintain the temperature of the stretched film to Tg or higher at least during a period from the stretching of the stretched film to the completion of the relaxation step.

According to one or more embodiments of the present invention, it is possible to obtain a film in which protruding of the rubber particles is suppressed even after the biaxial stretching and which is excellent in transparency and has a high strength in both the two-dimensional and three-dimensional directions. Regarding the transparency, the haze of the optical film obtained by one or more embodiments of the present invention as measured according to JIS K 7105 may be 1.0% or less, 0.8% or less, or 0.5% or less. In addition, regarding the strength, MIT of the optical film obtained by one or more embodiments of the present invention in both the flow direction and the width direction may be 1,000 times or more, or 1,100 times or more, and the ratio of MIT of the optical film in the flow direction to MIT of the optical film in the width direction may be 0.7 or more but 1.3 or less, or 0.8 or more but 1.2 or less. When the MIT and the ratio are within the above ranges, the optical film to be obtained is also excellent in isotropy. Incidentally, the MIT is the number of bendings at breakage measured according to JIS C 5016.

The average surface roughness Ra at a 5 μm viewing angle when the both surfaces of the optical film obtained by one or more embodiments of the present invention are observed with a scanning probe microscope is 0.1 nm or more but 4.0 nm or less, and a difference in average surface roughness between both the surfaces may be 2.0 nm or less. The average surface roughness may be 0.1 nm or more but 3 nm or less, and a difference in average surface roughness Ra between both the surfaces may be 1 nm or less. According to observation in such an ultramicroscopic range, the state where the rubber particles are present on the film surface can be recognized. When the average surface roughness Ra as an index of the unevenness state is within such a range, the both surfaces of the film are in a state where the protruding of the rubber particles is sufficiently suppressed, and the protruding of the rubber particles in the stretching step can be suppressed. As a result, whitening does not occur even in a film after the stretching that is a final form. When the difference in surface roughness between both the surfaces is more than 2.0 nm, deformation behaviors in respective stretching steps vary so that particles easily protrude at any one surface.

It may be possible that, in a stamping test where the optical film obtained by one or more embodiments of the present invention is punched in a dumbbell shape by using a punching machine and a circumference of the dumbbell is observed with an optical microscope, burr at end surfaces of the dumbbell is not observed.

The average film thickness of the optical film obtained by one or more embodiments of the present invention may be 15 to 60 μm from the viewpoint of strength and whitening.

In the biaxial stretching, if protruding of the particles on the surface is not suppressed in the melt extrusion method unlike one or more embodiments of the present invention, protruding of the rubber particles at the time of stretching becomes significant and light is scattered on the film surface. Thus, the film may be whitened. Such a film causes a decrease in brightness. However, according to one or more embodiments of the present invention, even in a film containing rubber particles, whitening can be effectively suppressed and thus the film can be suitably used as an optical film.

The thermoplastic resin composition that can be used in one or more embodiments of the present invention is not particularly limited as long as the thermoplastic resin composition can be used as an optical film and can be molded by melt extrusion. Examples of the thermoplastic resin composition include thermoplastic resin compositions such as polycarbonate resins, aromatic vinyl-based resins, and hydrogenated products thereof, and thermoplastic resin compositions containing rubber particles and thermoplastic resins such as polyolefin-based resins, acrylic resins, polyester-based resins, polyarylate resins, polyimide-based resins, polyethersulfone resins, polyamide-based resins, cellulose-based resins, and polyphenylene oxide resins.

A thermoplastic resin composition containing rubber particles can be used as a material of an optical film, but there is a case where the rubber particles are present on the surface of the film so that the surface smoothness of the film is impaired. In this case, it is expected that the surface smoothness of the film will be improved by pushing the rubber particles into the film by insertion molding performed after melt extrusion. However, when the compatibility between the rubber particles and a matrix resin is low, the rubber particles are likely to aggregate in the film, and as a result, surface irregularities of the film become large. In this case, surface minute irregularities cannot be reduced by insertion molding performed under normal conditions, and as a result, there is a disadvantage that the optical film has undesired surface unevenness.

However, according to one or more embodiments of the present invention, even when the thermoplastic resin composition contains rubber particles and the compatibility of the rubber particles with the matrix resin is low, minute surface irregularities can be reduced to achieve the effect of reducing surface unevenness.

Hereinafter, a rubbery polymer-containing acrylic resin composition will be specifically described as an example of the rubber particle-containing thermoplastic resin composition that can be appropriately used in one or more embodiments of the present invention.

The rubbery polymer may be, for example, a polymer having a glass transition temperature of lower than 20° C., and more specific examples thereof include a butadiene-based cross-linked polymer, a (meth)acrylic cross-linked polymer, and an organosiloxane-based cross-linked polymer. Among them, a (meth)acrylic cross-linked polymer (acrylic rubbery polymer) may be used from the viewpoint of the weatherability (light resistance) and transparency of the film. Examples of the acrylic rubbery polymer include ABS resin rubber and ASA resin rubber.

As the rubbery polymer, a graft copolymer containing a rubbery polymer may be used. The graft copolymer includes a multi-stage polymer and a multi-layered polymer. The multi-stage polymer is a polymer obtained by polymerizing a monomer mixture in the presence of polymer particles, and the multi-layered polymer is a polymer having polymer layers obtained by polymerizing a monomer mixture in the presence of polymer particles. Both the polymers are basically identical, but the former is a polymer mainly identified by a production method, and the latter is a polymer mainly identified by a layer structure. The following description will be made mainly with reference to the former, but apply equally to the latter.

From the viewpoint of transparency or the like, the following acrylic graft copolymer containing an acrylic ester-based rubbery polymer (hereinafter, simply referred to as “acrylic graft copolymer”) can be used. The acrylic graft copolymer can be obtained by polymerizing, in at least one or more stages, a monomer mixture mainly containing a methacrylic ester in the presence of an acrylic ester-based rubbery polymer.

In one or more embodiments, the acrylic ester-based rubbery polymer is a rubbery polymer mainly containing an acrylic ester, and specifically, the acrylic ester-based rubbery polymer may be a polymer obtained by polymerization of a monomer mixture (100% by weight) composed of 50 to 100% by weight of an acrylic ester and 50 to 0% by weight of another copolymerizable vinyl-based monomer and 0.05 to 10 parts by weight (with respect to 100 parts by weight of the monomer mixture) of a polyfunctional monomer having two or more unconjugated reactive double bonds per molecule. The polymerization may be performed using a mixture of all the monomers or may be performed in two or more stages by changing the composition of the monomers.

The acrylic ester to be used may be one having an alkyl group with 1 to 12 carbon atoms in terms of polymerizability and cost. Examples of the acrylic ester include methyl acrylate, ethyl acrylate, propyl acrylate, n-butyl acrylate, 2-butyl acrylate, isobutyl acrylate, benzyl acrylate, cyclohexyl acrylate, 2-ethylhexyl acrylate, and n-octyl acrylate. These monomers may be used in combination of two or more kinds thereof. The amount of the acrylic ester may be 50% by weight or more but 100% by weight or less, 60% by weight or more but 99% by weight or less, 70% by weight or more but 99% by weight or less, or 80% by weight or more but 99% by weight or less with respect to 100% by weight of the monomer mixture. When the amount of the acrylic ester is 50% by weight or more, there is a tendency that impact resistance is less likely to reduce, tensile elongation at breakage is less likely to reduce, and burr at the end surfaces at the time of cutting the film is less likely to occur.

The another copolymerizable vinyl-based monomer may be a (meth)acrylic ester in terms of weatherability and transparency. Examples of the (meth)acrylic ester include methyl methacrylate, ethyl methacrylate, propyl methacrylate, n-butyl methacrylate, 2-butyl methacrylate, isobutyl methacrylate, benzyl methacrylate, cyclohexyl methacrylate, phenoxyethyl (meth)acrylate, and phenyl (meth)acrylate. Further, aromatic vinyls, and derivatives thereof and vinyl cyanides may also be used, and examples thereof include styrene, methyl styrene, acrylonitrile, and methacrylonitrile. Other examples of the another copolymerizable vinyl-based monomer include unsubstituted and/or substituted maleic anhydrides, (meth)acrylamides, vinyl esters, vinylidene halides, (meth)acrylic acid and salts thereof, and (hydroxyalkyl) acrylic esters.

The polyfunctional monomer may be a commonly-used one, and examples thereof include allyl methacrylate, allyl acrylate, triallyl cyanurate, triallyl isocyanurate, diallyl phthalate, diallyl maleate, divinyl adipate, divinyl benzene, ethylene glycol dimethacrylate, diethylene glycol methacrylate, triethylene glycol dimethacrylate, trimethylol propane trimethacrylate, tetramethylol methane tetramethacrylate, dipropylene glycol dimethacrylate, and acrylates thereof. Two or more kinds of these polyfunctional monomers may be used.

The amount of the polyfunctional monomer may be 0.05 to 10 parts by weight or 0.1 to 5 parts by weight with respect to 100 parts by weight of the total amount of the monomer mixture. When the amount of the polyfunctional monomer added is 0.05 part by weight or more, a cross-linked polymer tends to be likely to be formed. When the amount of the polyfunctional monomer added is 10 parts by weight or less, crack resistance of the film tends to be less likely to reduce.

The average particle size of the rubbery polymer may be 20 to 450 nm, 20 to 300 nm, 20 to 150 nm, or 30 to 80 nm. When the average particle size is 20 nm or more, crack resistance is less likely to deteriorate. On the other hand, when the average particle size is 450 nm or less, transparency is less likely to reduce. Incidentally, in the present specification, the average particle size means an average particle size measured by a dynamic scattering method and, for example, can be measured by using MICROTRAC UPA150 (manufactured by NIKKISO CO., LTD.).

The acrylic graft copolymer may be one obtained by polymerizing, in at least one stage, 95 to 25 parts by weight of a monomer mixture mainly containing a methacrylic ester in the presence of 5 to 90 parts by weight (for example, 5 to 75 parts by weight) of the acrylic ester-based rubbery polymer. The amount of the methacrylic ester in the graft copolymerization composition (monomer mixture) may be 50% by weight or more. When the amount of the methacrylic ester is 50% by weight or more, there is a tendency that hardness and rigidity of the film are less likely to reduce. As a monomer used for the graft copolymer, the above-described methacrylic ester, acrylic ester, or vinyl-based monomer copolymerizable therewith can be used, and the methacrylic ester or the acrylic ester is suitably used. From the viewpoint of compatibility with the acrylic resin, methyl methacrylate may be used, and from the viewpoint of suppressing zipper-like depolymerization, methyl acrylate, ethyl acrylate, or n-butyl acrylate may be used.

From the viewpoint of optical isotropy, a (meth)acrylic monomer having an alicyclic structure, a heterocyclic structure, or an aromatic group (referred to as “ring structure-containing (meth)acrylic monomer”) may be used, and specific examples of such a ring structure-containing (meth)acrylic monomer include benzyl (meth)acrylate, dicyclopentanyl (meth)acrylate, and phenoxyethyl (meth)acrylate. The amount of the ring structure-containing (meth)acrylic monomer to be used may be 1 to 100% by weight, 5 to 70% by weight, or 5 to 50% by weight with respect to 100% by weight of the total amount of the monomer mixture (total amount of the ring structure-containing (meth)acrylic monomer and another monofunctional monomer copolymerizable therewith). For the another monofunctional monomer copolymerizable therewith described herein, the aforementioned methacrylic ester, acrylic ester, or another copolymerizable vinyl-based monomer can be similarly used.

The acrylic graft copolymer may be one further containing a hard polymer inside a rubbery polymer.

Specifically, a multi-stage polymer obtained by multi-stage polymerization including the following polymerization stages (I) to (III) is exemplified.
(I) A hard polymer is obtained by polymerization of a mixture (a) formed from 40 to 100% by weight of a methacrylic ester and 60 to 0% by weight of another monomer having a double bond copolymerizable therewith and 0.01 to 10 parts by weight of a polyfunctional monomer (with respect to 100 parts by weight of the total amount of the monomer mixture (a)).
(II) A soft polymer is obtained by polymerization of a monomer mixture (b) formed from 60 to 100% by weight of an acrylic ester and 0 to 40% by weight of another monomer having a double bond copolymerizable therewith and 0.1 to 5 parts by weight of a polyfunctional monomer. In the polymerization stage (III), a hard polymer is obtained by polymerization of a monomer mixture (c) formed from 60 to 100% by weight of a methacrylic ester and 40 to 0% by weight of another monomer having a double bond copolymerizable therewith and 0 to 10 parts by weight of a polyfunctional monomer (with respect to 100 parts by weight of the total amount of the monomer mixture (c)).

The acrylic graft copolymer may be a multi-stage polymer obtained by polymerization through the polymerization stages (I) to (III) in this order, and another polymerization stage may be included among the respective polymerization stages (I) to (III).

Herein, the methacrylic ester, the acrylic ester, the monomer having a double bond copolymerizable therewith, and the polyfunctional monomer may be the same as those described in the above examples.

The multi-stage polymer may be one obtained by multi-stage polymerization further including a polymerization stage (IV).
(IV) A hard polymer is obtained by polymerization of a monomer mixture (d) formed from 40 to 100% by weight of a methacrylic ester, 0 to 60% by weight of an acrylic ester, and 0 to 5% by weight of another monomer having a double bond copolymerizable therewith and 0 to 10 parts by weight of a polyfunctional monomer (with respect to 100 parts by weight of the monomer mixture (d)).

The methacrylic ester, the acrylic ester, the another monomer having a double bond copolymerizable therewith, and the polyfunctional monomer used in (IV) may be the same as those described in the above examples.

The term “soft” described herein means that the glass transition temperature of the polymer is lower than 20° C. From the viewpoint of enhancing the impact absorption capacity of the soft layer and enhancing an impact resistance improving effect such as crack resistance, the glass transition temperature of the polymer may be lower than 0° C. or lower than −20° C.

Further, the term “hard” described herein means that the glass transition temperature of the polymer is 20° C. or higher. When the glass transition temperature of the polymer is 20° C. or higher, a problem that the resin composition and the molded body that contain a cross-linked structure-containing polymer have low heat resistance or that coarsening or agglomeration of the cross-linked structure-containing polymer is likely to occur when the cross-linked structure-containing polymer is produced is less likely to occur.

In this application, the glass transition temperature of the “soft” and “hard” polymers is calculated by Fox equation using a value described in Polymer Hand Book (J. Brandrup, Interscience 1989) (for example, the glass transition temperature of polymethyl methacrylate is 105° C. and the glass transition temperature of polybutyl acrylate is −54° C.)

In a case where a film is stretched and then used (in the case of using a stretched film), it may be possible to use a multi-stage polymerization graft copolymer obtained by multi-stage polymerization including one or more polymerization stages of forming a hard polymer, which includes at least the polymerization stage (IV), before and/or after the polymerization stage (III). For example, it may be possible to use a multi-stage polymerization graft copolymer obtained by four-stage polymerization including the polymerization stage (I), the polymerization stage (II), the polymerization stage (III), and the polymerization stage (IV). The polymerization stage (IV) may be provided before or after the polymerization stage (III) as long as it is a polymerization stage after the polymerization stage (II).

Incidentally, the order of the polymerization stage (III) and the polymerization stage (IV) is not particularly limited, and any of the polymerization stage (III) and the polymerization stage (IV) may be firstly performed. It may be possible to perform polymerization in the polymerization stage (III) and then to perform polymerization in the polymerization stage (IV).

The graft rate with respect to the acrylic ester-based rubbery polymer may be 10 to 250%, 40 to 230%, or 60 to 220%. When the graft rate is 10% or more, the acrylic graft copolymer is less likely to aggregate in a molded body, and there is less concern that transparency is reduced or foreign matters are generated. Further, there are tendencies that tensile elongation at breakage is less likely to reduce and burr is less likely to occur at the time of cutting the film. When the graft rate is 250% or less, there are tendencies that melt viscosity is less likely to increase at the time of molding, for example, molding the film and film moldability is less likely to reduce. The calculation formula will be described below.

Incidentally, in the case of the multi-stage polymer, the graft rate indicates a ratio of the weight added with a polymer obtained in the subsequent stage of the polymerization stage (II) to the weight of the soft polymer obtained by the polymerization stage (II) when the weight of the soft polymer obtained by performing polymerization until the polymerization stage (II) of the multi-stage polymerization including the polymerization stages (I) and (II) is 100.

The graft rate is the weight ratio of graft component in the acrylic graft copolymer, and is measured in the following manner. 2 g of the obtained acrylic graft copolymer is dissolved in 50 ml of methyl ethyl ketone, and the obtained solution is separated into an insoluble fraction and a soluble fraction by centrifugation using a centrifugal separator (CP 60E manufactured by Hitachi Koki Co., Ltd.) at a rotation speed of 30,000 rpm and a temperature of 12° C. for 1 hour (three sets of centrifugation are performed in total). The obtained insoluble fraction is considered as the acrylic ester-based graft polymer and the graft rate is calculated by the following formula.

Graft rate (%)=[{(weight of methyl ethyl ketone insoluble fraction)−(weight of acrylic ester-based rubbery polymer)}/(weight of acrylic ester-based rubbery polymer)]×100

The acrylic graft copolymer can be produced by a common emulsion polymerization method. Specifically, a method in which an acrylic ester monomer is continuously polymerized using an emulsifier in the presence of a water-soluble polymerization initiator can be exemplified.

In the emulsion polymerization method, continuous polymerization may be performed in a single reaction tank. When two or more reaction tanks are used, the mechanical stability of a latex may be reduced.

A polymerization temperature may be 30° C. or higher but 100° C. or lower, or 50° C. or higher but 80° C. or lower. When the polymerization temperature is 30° C. or higher, productivity tends to be less likely to reduce, and when the polymerization temperature is 100° C. or lower, a target molecular weight tends to be less likely to be excessively large so that quality tends to be less likely to reduce. Raw materials such as an acrylic ester monomer, an initiator, an emulsifier, and a deionized water to be continuously added to a polymerization reactor are accurately added to the polymerization reactor under the control of metering pumps, and as necessary, may be previously cooled to ensure the amount of heat removal to remove heat generated by polymerization in the reactor. As necessary, a polymerization inhibitor, a coagulant, a flame retardant, an antioxidant, or a pH regulator may be added to a latex discharged from the reactor, the unreacted monomer may be recovered, or post-polymerization may be performed. Thereafter, a copolymer can be obtained by performing coagulation, heat treatment, dehydration, washing with water, and drying according to a known method.

In the emulsion polymerization, a common polymerization initiator can be used. Examples of the polymerization initiator to be used include inorganic peroxides such as potassium persulfate and sodium persulfate, organic peroxides such as cumene hydroperoxide and benzoyl peroxide, and oil-soluble initiators such as azobisisobutyronitrile. These initiators may be used singly or in combination of two or more kinds thereof. Each of these initiators may be combined with a reducing agent such as sodium sulfite, sodium thiosulfate, sodium formaldehyde, sulfoxylate, ascorbic acid, or a complex of ferrous sulfate and disodium ethylenediaminetetraacetate so as to be used as a common redox-type polymerization initiator.

The polymerization initiator may be used in combination with a chain transfer agent. Examples of the chain transfer agent include alkyl mercaptans having 2 to 20 carbon atoms, mercapto acids, thiophenol, and carbon tetrachloride. These chain transfer agents may be used singly or in combination of two or more kinds thereof.

The emulsifier used in the emulsion polymerization method is not particularly limited as long as the emulsifier is a common emulsifier for emulsion polymerization. Examples of the emulsifier include anionic surfactants such as a sulfuric acid ester salt-based surfactant (for example, sodium alkyl sulfate), a sulfonate-based surfactant (for example, sodium alkylbenzene sulfonate, sodium alkyl sulfonate, or sodium dioctyl sulfosuccinate), and a phosphate-based surfactant (for example, sodium alkyl phosphate or sodium polyoxyethylene alkyl ether phosphate). The above-mentioned sodium salts may be other alkali metal salts such as potassium salts or ammonium salts. These emulsifiers may be used singly or in combination of two or more kinds thereof. Further, a nonionic surfactant typified by polyoxyalkylene or a derivative thereof obtained by substituting its terminal hydroxyl group with alkyl or aryl may be used or may be partially combined. Among them, in terms of polymerization reaction stability and particle size controllability, a sulfonate-based surfactant or a phosphate-based surfactant may be used, and particularly, dioctyl sulfosuccinate or polyoxyethylene alkyl ether phosphoric acid ester can be used.

The amount of the emulsifier to be used may be 0.05 part by weight or more but 10 parts by weight, or 0.1 part by weight or more but 1.0 part by weight or less with respect to the total 100 parts by weight of the monomer components. When the amount of the emulsifier is 0.05 part by weight or more, the particle size of the copolymer does not become excessively large, and when the amount of the emulsifier is 10 parts by weight or less, the particle size of the copolymer does not become excessively small and the particle size distribution is less likely to deteriorate.

Further, as necessary, a multi-stage polymerization graft copolymer latex which has not been subjected to a solidification operation is filtered with a filter, a mesh, or the like to remove fine polymer scales so that fish-eyes, foreign matters, or the like caused by these fine polymer scales are reduced and thus the appearance of the resin composition and the film according one or more embodiments of the present invention can be improved.

The rubbery polymer-containing acrylic resin composition in one or more embodiments of the present invention is not particularly limited, but may be a mixed composition of at least one or more acrylic rubbery polymers and at least one or more acrylic resins.

In one or more embodiments, the acrylic rubbery polymer is mixed so that the amount of the rubbery polymer contained in the acrylic rubbery polymer may be 1 to 60 parts by weight, 1 to 30 parts by weight, 1 to 25 parts by weight, or 5 to 20 parts by weight with respect to the total 100 parts by weight of the acrylic resin and the graft copolymer. When the amount of the rubbery polymer is 1 part by weight or more, the crack resistance or vacuum moldability of the film is less likely to deteriorate or the film is less likely to have poor optical isotropy due to a high photoelastic constant. On the other hand, when the amount of the rubbery polymer is 60 parts by weight or less, the heat resistance, surface hardness, transparency, and resistance to whitening on bending of the film tend to be less likely to deteriorate.

The acrylic rubbery polymer and the acrylic resin may be directly mixed when the film is produced, or the film may be produced using pellets previously formed by mixing the acrylic rubbery polymer and a methacrylic resin.

The acrylic resin is not particularly limited, but a methacrylic resin containing methyl methacrylate as a monomer component can be used and the methacrylic resin may be one containing 30 to 100% by weight of a methyl methacrylate structural unit. Further, a heat-resistant acrylic resin can be used, and examples thereof include an acrylic resin copolymerized with an N-substituted maleimide compound as a copolymerization component, a glutaric anhydride acrylic resin, an acrylic resin having a lactone ring structure, a glutarimide acrylic resin, an acrylic resin containing a hydroxyl group and/or a carboxyl group, an aromatic vinyl-containing polymer obtained by polymerization of an aromatic vinyl monomer and another monomer copolymerizable therewith or a hydrogenated aromatic vinyl-containing polymer obtained by partial or complete hydrogenation of aromatic rings thereof (for example, a partially-hydrogenated styrene-based polymer obtained by partial hydrogenation of aromatic rings of a styrene-based polymer obtained by polymerization of a styrene monomer and another monomer copolymerizable therewith), and an acrylic polymer containing a cyclic acid anhydride repeating unit. From the viewpoint of heat resistance and optical characteristics, a glutarimide acrylic resin can be used. The glutarimide acrylic resin will be described in detail below. As the glutarimide acrylic resin, specifically, it is possible to use a glutarimide acrylic resin containing a unit represented by the following General Formula (1)

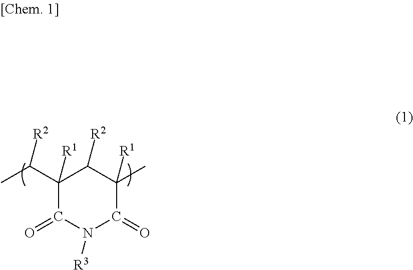

(in the formula, R¹ and R² are each independently hydrogen or an alkyl group having 1 to 8 carbon atoms and R³ is an alkyl group having 1 to 18 carbon atoms, a cycloalkyl group having 3 to 12 carbon atoms, or a substituent group containing an aromatic ring having 5 to 15 carbon atoms.) (hereinafter, also referred to as “glutarimide unit”), and a unit represented by the following General Formula (2)

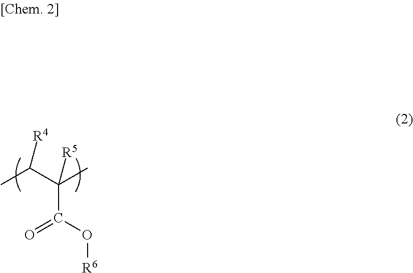

(in the formula, R⁴ and R⁵ are each independently hydrogen or an alkyl group having 1 to 8 carbon atoms and R⁶ is an alkyl group having 1 to 18 carbon atoms, a cycloalkyl group having 3 to 12 carbon atoms, or a substituent group containing an aromatic ring having 5 to 15 carbon atoms.) (hereinafter, also referred to as “(meth)acrylic ester unit”).

In addition, the glutarimide acrylic resin may further contain, if necessary, a unit represented by the following General Formula (3)

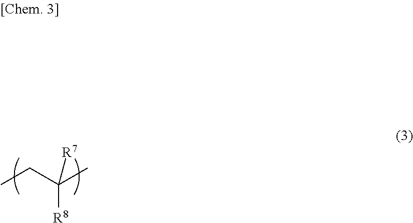

(in the formula, R⁷ is hydrogen or an alkyl group having 1 to 8 carbon atoms and R⁸ is an aryl group having 6 to 10 carbon atoms.) (hereinafter, also referred to as “aromatic vinyl unit”).

In the above General Formula (1), R¹ and R² may be each independently hydrogen or a methyl group, R³ may be hydrogen, a methyl group, a butyl group, or a cyclohexyl group, R¹, R², and R³ may be a methyl group, hydrogen, and a methyl group, respectively.

The glutarimide acrylic resin may contain only one kind of glutarimide unit or two or more kinds of glutarimide units different in R¹, R², and R³ in the above General Formula (1).

The glutarimide unit can be formed by imidizing the (meth)acrylic ester unit represented by the above General Formula (2).

Alternatively, the glutarimide unit can be formed by imidizing an acid anhydride such as maleic anhydride or a half ester obtained from such an acid anhydride and a linear or branched alcohol having 1 to 20 carbon atoms; or an α, β-ethylenic unsaturated carboxylic acid such as acrylic acid, methacrylic acid, maleic acid, maleic anhydride, itaconic acid, itaconic anhydride, crotonic acid, fumaric acid, or citraconic acid.

In the above General Formula (2), R⁴ and R⁵ may be each independently hydrogen or a methyl group, R⁶ may be hydrogen or a methyl group, and R⁴, R⁵, and R⁶ may be hydrogen, a methyl group, and a methyl group, respectively.

The glutarimide acrylic resin may contain only one kind of (meth)acrylic ester unit or two or more kinds of (meth) acrylic ester units different in R⁴, R⁵, and R⁶ in the above General Formula (2).

The glutarimide resin may contain styrene, α-methyl styrene, or the like, and may contain styrene as the aromatic vinyl structural unit represented by the above General Formula (3) .

Further, the glutarimide acrylic resin may contain only one kind of aromatic vinyl structural unit or two or more kinds of aromatic vinyl structural units different in R⁷ and R⁸.

The content of the glutarimide unit represented by General Formula (1) in the glutarimide acrylic resin is not particularly limited, and may be changed depending on, for example, the structure of R³.

In general, the content of the glutarimide unit may be 1% by weight or more, 1% by weight to 95% by weight, 2% by weight to 90% by weight, or 3% by weight to 80% by weight of the glutarimide resin.

When the content of the glutarimide unit is within the above range, heat resistance and transparency of the glutarimide resin to be obtained are less likely to reduce or molding processability and the mechanical strength of a film obtained by processing the obtained glutarimide resin into a film are less likely to reduce.

The content of the aromatic vinyl unit represented by General Formula (3) in the glutarimide acrylic resin is not particularly limited, and may be appropriately set depending on desired physical properties. Depending on the intended use, the content of the aromatic vinyl unit represented by General Formula (3) may be 0. When the glutarimide acrylic resin contains the aromatic vinyl unit represented by General Formula (3), the content of the aromatic vinyl unit may be 10% by weight or more, 10% by weight to 40% by weight, 15% by weight to 30% by weight, or 15% by weight to 25% by weight based on the total repeating unit of the glutarimide acrylic resin.

When the content of the aromatic vinyl unit is within the above range, heat resistance of the glutarimide acrylic resin to be obtained is less likely to become insufficient or mechanical strength of a film obtained by processing the obtained glutarimide resin into a film is less likely to reduce.

The glutarimide acrylic resin may further be copolymerized with another unit other than the glutarimide unit, the (meth)acrylic ester unit, and the aromatic vinyl unit, as necessary.

The another unit may be, for example, a structural unit obtained by copolymerization of a nitrile-based monomer such as acrylonitrile or methacrylonitrile or a maleimide-based monomer such as maleimide, N-methyl maleimide, N-phenyl maleimide, or N-cyclohexyl maleimide.

Such another unit may be directly copolymerized or graft-copolymerized with the glutarimide acrylic resin. The weight average molecular weight of the glutarimide acrylic resin is not particularly limited, but may be 1×10⁴ to 5×10⁵. When the weight average molecular weight is within the above range, viscosity during melt extrusion is less likely to increase, molding processability is less likely to reduce, productivity of a molded article is less likely to reduce, or mechanical strength of a film obtained by processing the obtained glutarimide resin into a film is less likely to become insufficient.

Further, the glass transition temperature of the glutarimide acrylic resin is not particularly limited, but may be 110° C. or higher, or 120° C. or higher. When the glass transition temperature is within the above range, it is possible to extend the range of application of the thermoplastic resin composition to be obtained.

A method for producing the glutarimide acrylic resin is not particularly limited, and may be, for example, the method described in Japanese Unexamined Patent Application, Publication No. 2008-273140.

The thermoplastic resin composition used in one or more embodiments of the present invention may contain an agent for improving thermal stability or light stability such as an antioxidant, a UV absorber, or a UV stabilizer. These agents may be used singly or in combination of two or more kinds thereof.

The optical film produced by one or more embodiments of the present invention can be used as a member for use in a display device such as a liquid crystal display, for example, a polarizer protective film, a phase difference film, a brightness enhancement film, a liquid crystal substrate, a light diffusion sheet, a prism sheet, or the like. Among them, the optical film is suitable for use as a polarizer protective film or a phase difference film.

### EXAMPLES

Hereinafter, one or more embodiments of the present invention will be described in more detail based on Examples, but the present invention is not limited to these Examples. Incidentally, methods for measuring various physical properties measured in the following Examples and Comparative Examples are as follows.

### (Glass Transition Temperature)

The glass transition temperature of a sample was determined using a differential scanning calorimeter (DSC) SSC-5200 manufactured by Seiko Instruments Inc. in the following manner. The sample was preliminarily treated by once increasing the temperature of the sample to 200° C. at a rate of 25° C./min, holding the sample at 200° C. for 10 minutes, and decreasing the temperature of the sample to 50° C. at a rate of 25° C./min. Then, the DSC curve of the sample was measured while the temperature of the sample was increased to 200° C. at a temperature increase rate of 10° C./min. The integral of the obtained DSC curve (DDSC) was determined, and the glass transition temperature of the sample was determined from the maximum point of DDSC.

### (Orientation Birefringence)

A test piece of 40 mm×40 mm was cut out from the film, and then the in-plane phase difference thereof was measured using an automatic birefringence meter (KOBRA-WR) manufactured by Oji Scientific Instruments Co., Ltd. at a wavelength of 590 nm and an incident angle of 0°. Then, the in-plane phase difference was divided by the thickness of the test piece to calculate orientation birefringence.

### (Photoelastic Constant)

A strip-shaped test piece was cut out from the film to be 90 mm in the film width direction×15 mm in the film flow direction. Then, the birefringence of the film was measured using an automatic birefringence meter (KOBRA-WR) manufactured by Oji Scientific Instruments Co., Ltd. at a wavelength of 590 nm and an incident angle of 0°. The birefringence was measured in a state where one of the long sides of the film was fixed, and a load ranging from 0 kgf to 4 kgf was applied in increments of 0.5 kgf to the other long side. From the obtained result, the amount of birefringence change under unit stress was calculated.

### (Haze)

The haze value of the film was measured using a turbidity meter (NDH-300A) manufactured by NIPPON DENSHOKU INDUSTRIES CO., LTD. by the method described in JIS K 7105.

### (Bending Resistance)

The bending resistance of the film was measured using MIT Folding Endurance Tester manufactured by Toyo Seiki Seisaku-sho, Ltd. by the method of JIS C 5016. The measurement conditions were set to R=0.38 and a load of 100 g. The measurement result is described as the number of bendings at breakage (hereinafter, referred to as “MIT” in some cases).

### (Stamping Test)

In the stamping test, the stretched film was punched in a dumbbell shape by using a punching machine, and then observation on whether the circumference of the dumbbell does not have burr or the like and is smooth was carried out with an optical microscope.

### Production Example 1

### <Production of Glutarimide Acrylic Resin (A1)>

A glutarimide acrylic resin (A1) was produced using polymethyl methacrylate as a raw material resin and monomethylamine as an imidization agent. In this production, a tandem-type reactive extruder was used in which two extrusion reactors were arranged in series. The tandem-type reactive extruder had a first extruder and a second extruder, and both the extruders were intermeshing co-rotating twin screw extruders having a diameter of 75 mm and an L/D (a ratio of a length L to a diameter D of the extruder) of 74. The raw material resin was supplied to the raw material supply port of the first extruder using a loss-in-weight feeder (manufactured by Kubota Corporation). The pressure in each of the vents of the first extruder and the second extruder was reduced to −0.095 MPa. Further, the first extruder and the second extruder were connected through a pipe having a diameter of 38 mm and a length of 2 m, and a constant flow pressure valve was used as a mechanism for controlling the pressure in a part connecting the resin discharge port of the first extruder and the raw material supply port of the second extruder. A resin (strand) discharged from the second extruder was cooled on a cooling conveyer and then cut into pellets by a pelletizer. Herein, in order to adjust the pressure in the part connecting the resin discharge port of the first extruder and the raw material supply port of the second extruder or to detect uneven extrusion, resin pressure meters were provided at the discharge port of the first extruder, the center of the part connecting the first extruder and the second extruder, and the discharge port of the second extruder. In the first extruder, a polymethyl methacrylate resin (Mw: 105,000) was used as a raw material resin and monomethylamine was used as an imidization agent to produce an imide resin intermediate 1. At this time, the temperature of the maximum temperature portion of the extruder was 280° C., the screw rotation speed of the extruder was 55 rpm, the amount of the raw material resin supplied was 150 kg/h, and the amount of monomethylamine added was 2.0 parts by weight with respect to 100 parts by weight of the raw material resin. The constant flow pressure valve was provided just before the raw material supply port of the second extruder to adjust the pressure in the monomethylamine injection portion of the first extruder to 8 MPa. In the second extruder, the remaining imidization agent and a by-product were devolatilized through a rear vent and a vacuum vent, and then dimethyl carbonate was added as an esterification agent to produce an imide resin intermediate 2. At this time, the temperature of each barrel of the extruder was 260° C., the screw rotation speed of the extruder was 55 rpm, and the amount of dimethyl carbonate added was 3.2 parts by weight with respect to 100 parts by weight of the raw material resin. Further, the esterification agent was removed through a vent, and then the resultant product was extruded through a strand die, cooled in a water bath, and pelletized by a pelletizer, thereby obtaining a glutarimide acrylic resin (A1). The obtained glutarimide acrylic resin (A1) is an acrylic resin obtained by copolymerization of a glutarimide unit and a (meth)acrylic ester unit.

### Production Example 2

### <Production of Graft Copolymer (B2)>

The following materials were charged into an 8-liter polymerization apparatus equipped with a stirrer. Deionized water 175 parts by weight Polyoxyethylene lauryl ether phosphate 0.104 part by weight Boric acid 0.4725 part by weight Sodium carbonate 0.04725 part by weight The inside of the polymerization apparatus was sufficiently purged with nitrogen gas. Then, the temperature inside the polymerization apparatus was adjusted to 80° C., and 27 parts by weight of a monomer mixture (97% by weight of methyl methacrylate and 3% by weight of butyl acrylate) and 26% by weight of a mixture (I) formed from 0.135 part by weight of allyl methacrylate were collectively added, and then 0.0645 part by weight of sodium formaldehyde sulfoxylate, 0.0056 part by weight of disodium ethylenediaminetetraacetate, 0.0014 part by weight of ferrous sulfate, and 0.0207 part by weight of t-butyl hydroperoxide were added thereto. After 15 minutes, 0.0345 part by weight of t-butyl hydroperoxide was added thereto and then polymerization was further continued for 15 minutes. Then, 0.0098 part by weight of sodium hydroxide was added in the form of 2% by weight of aqueous solution, 0.0852 part by weight of polyoxyethylene lauryl ether phosphate was added without any change, and the remaining 74% by weight of the mixture (I) was continuously added over 60 minutes. After 30 minutes from the completion of the addition, 0.069 part by weight of t-butyl hydroperoxide was added and polymerization was further continued for 30 minutes to obtain a polymer. The polymerization conversion rate was 100.0%. Then, 0.0267 part by weight of sodium hydroxide was added in the form of 2% by weight of aqueous solution, 0.08 part by weight of potassium persulfate was added in the form of 2% by weight of aqueous solution, and then 50 parts by weight of a monomer mixture (82% by weight of butyl acrylate and 18% by weight of styrene) and a mixture formed from 0.75 part by weight of allyl methacrylate were continuously added over 150 minutes. After the completion of the addition, 0.015 part by weight of potassium persulfate was added in the form of 2% by weight of aqueous solution and polymerization was continued for 120 minutes to obtain a polymer. The polymerization conversion rate was 99.0% and the average particle size was 225 nm. Then, 0.023 part by weight of potassium persulfate was added in the form of 2% by weight of aqueous solution, 15 parts by weight of the monomer mixture (95% by weight of methyl methacrylate and 5% by weight of butyl acrylate) was continuously added over 45 minutes, and polymerization was further continued for 30 minutes. Thereafter, 8 parts by weight of the monomer mixture (52% by weight of methyl methacrylate and 48% by weight of butyl acrylate) was continuously added over 25 minutes, and polymerization was further continued for 60 minutes to obtain a graft copolymer latex. The polymerization conversion rate was 100.0%. The obtained latex was subjected to salting-out and coagulation with magnesium chloride, washing with water, and drying to obtain a white powdery graft copolymer (B2). The graft rate of the graft copolymer (B2) was 24.2%.

### Production Example 3

### <Production 1 of Resin Pellets>

A single screw extruder using a full flight screw having a diameter of 40 mm was used, the temperature of the temperature control zone of the extruder was set to 255° C., the screw rotation speed of the extruder was set to 52 rpm, and a mixture of 95 parts by weight of the glutarimide acrylic resin (A1) and 5 parts by weight of the white powdery graft copolymer (B2) was supplied at a rate of 10 kg/hr. The resin discharged as a strand from a die provided at the outlet of the extruder was cooled in a water tank and pelletized by a pelletizer. The melt viscosity of the pellets was measured in the above-described manner.

### Production Example 4

### <Production 2 of Resin Pellets>

A single screw extruder using a full flight screw having a diameter of 40 mm was used, the temperature of the temperature control zone of the extruder was set to 255° C., the screw rotation speed of the extruder was set to 52 rpm, and only the glutarimide acrylic resin (A1) was supplied at a rate of 10 kg/hr. The resin discharged as a strand from a die provided at the outlet of the extruder was cooled in a water tank and pelletized by a pelletizer. The melt viscosity of the pellets was measured in the above-described manner.

### Example 1

The pellets (glass transition temperature Tg: 122° C.) obtained in Production Example 3 were used as a rubber-containing thermoplastic resin composition. The pellets were dried in a drier at 80° C. for 4 hours and then supplied to a 065 mm single screw extruder. Screen meshes #40, #100, #400, #400, #100, and #40 were provided at the outlet of the extruder in layers in this order from the extruder side. The pellets were melted by heating so that the resin temperature at the outlet of the extruder was 270° C., and the resultant molten resin was allowed to pass through a leaf disk filter (pore size: 5 μm cut) and then extruded through a gear pump into a T-die. At this time, the resin temperature at the outlet of the T-die just after discharge was 270° C., and the melt viscosity of the pellets at this temperature and 122 sec⁻¹ was 1,050 Pa·sec. The discharged molten film was inserted between a cast roll adjusted to 70° C. and a touch roll adjusted to 70° C. so as to be cooled and solidified and then the solidified film was taken up by a take-up roll to obtain a 160 μm-thick original film. This original film was stretched by a simultaneous biaxial stretching machine (the length of the heat treatment zone/the length of the stretching zone=1.0) in both the longitudinal direction and the transverse direction under conditions of twice and 132° C. (Tg+10° C.), and in the heat treatment zone, the resultant stretched film was relaxed by 5% in both the longitudinal direction and the transverse direction (that is, the size was reduced by 5% in both the longitudinal direction and the transverse direction) while the heat treatment was performed at 135° C. and then cooled to Tg or lower. After the both ends of the cooled film were continuously slit, the film was taken up by the take-up roll to obtain a 40 μm-thick film wound around a core. The haze of the obtained stretched film was 0.5%, MIT in the longitudinal direction was 2,500 times, MIT in the transverse direction was 2,500 times, and burr at the end surfaces of the dumbbell in the stamping test was not observed.

### Example 2

A 40 μm-thick biaxially stretched film was obtained in the same manner as in Example 1, except that the heat treatment temperature was changed to 132° C. The haze of the obtained stretched film was 0.7%, MIT in the longitudinal direction was 2,900 times, MIT in the transverse direction was 2,900 times, and burr at the end surfaces of the dumbbell in the stamping test was not observed.

### Example 3

A 40 μm-thick biaxially stretched film was obtained in the same manner as in Example 1, except that the stretching temperature was changed to 125° C. and the heat treatment temperature was changed to 145° C. The haze of the obtained stretched film was 0.4%, MIT in the longitudinal direction was 2,000 times, MIT in the transverse direction was 2,000 times, and burr at the end surfaces of the dumbbell in the stamping test was not observed.

### Comparative Example 1

A 40 μm-thick biaxially stretched film was obtained in the same manner as in Example 1, except that cooling to Tg or lower was carried out after the stretching zone without providing the heat treatment zone. The haze of the obtained stretched film was 1.8%, MIT in the longitudinal direction was 3,000 times, MIT in the transverse direction was 3,000 times, and burr at the end surfaces of the dumbbell in the stamping test was observed at several places. The average surface roughnesses Ra of the surfaces of the film at a 5 μm viewing angle were 11.1 nm and 10.0 nm, respectively.

### Comparative Example 2

Although the procedure of Example 1 was repeated, except that the heat treatment temperature was changed to 155° C., the film slacked in the heat treatment zone and the film was brought into contact with the nozzle in the stretching machine so that the film was broken.

### Comparative Example 3

A 40 μm-thick biaxially stretched film was obtained in the same manner as in Example 1, except that the stretching temperature was changed to 145° C. and the heat treatment temperature was changed to 145° C. The haze of the obtained stretched film was 0.4%, MIT in the longitudinal direction was 1,000 times, MIT in the transverse direction was 1,000 times, and burr at the end surfaces of the dumbbell in the stamping test was observed at several places.

### Comparative Example 4

A 40 μm-thick biaxially stretched film was obtained in the same manner as in Example 1, except that the stretching temperature was changed to 125° C. and the heat treatment temperature was changed to 122° C. The haze of the obtained stretched film was 2.1%, MIT in the longitudinal direction was 2,900 times, MIT in the transverse direction was 2,900 times, and burr at the end surfaces of the dumbbell in the stamping test was not observed.

### Comparative Example 5

The pellets (glass transition temperature Tg: 122° C.) obtained in Production Example 3 were used as a rubber-containing thermoplastic resin composition. The pellets were dried in a drier at 80° C. for 4 hours and then supplied to a 065 mm single screw extruder. Screen meshes #40, #100, #400, #400, #100, and #40 were provided at the outlet of the extruder in layers in this order from the extruder side. The pellets were melted by heating so that the resin temperature at the outlet of the extruder was 270° C., and the resultant molten resin was allowed to pass through a leaf disk filter (pore size: 5 μm cut) and then extruded through a gear pump into a T-die. At this time, the resin temperature at the outlet of the T-die just after discharge was 270° C., and the melt viscosity of the pellets at this temperature and 122 sec⁻¹ was 1,050 Pa·sec. The discharged molten film was inserted between a cast roll adjusted to 70° C. and a touch roll adjusted to 70° C. so as to be cooled and solidified and then the solidified film was taken up by a take-up roll to obtain a 140 μm-thick original film. The original film line velocity at this time was 15 m/min. This original film was continuously stretched by a longitudinal stretching machine using a roll in the longitudinal direction under conditions of twice and 145° C. (Tg+23° C.), and then was further continuously stretched by a lateral stretching machine using a clip-type tenter (the length of the heat treatment zone/the length of the stretching zone=1.0) in the transverse direction under conditions of twice and 145° C. (Tg+23° C.), and then the resultant stretched film was cooled to Tg or lower after the stretching zone without providing the heat treatment zone. After the both ends of the cooled film were continuously slit, the film was taken up by the take-up roll to obtain a 40 μm-thick biaxially stretched film wound around a core. The haze of the obtained stretched film was 1.1%, MIT in the longitudinal direction was 1,200 times, MIT in the transverse direction was 1,200 times, and burr at the end surfaces of the dumbbell in the stamping test was not observed.

### Comparative Example 6

A 40 μm-thick biaxially stretched film was obtained in the same manner as in Example 1, except that a thermoplastic resin not mixed with the rubber obtained in Production Example 4 was used as pellets. The haze of the obtained stretched film was 0.2%, MIT in the longitudinal direction was 400 times, MIT in the transverse direction was 400 times, and burr at the end surfaces of the dumbbell in the stamping test was observed at several places.

### Comparative Example 7

A 40 μm-thick biaxially stretched film was obtained in the same manner as in Comparative Example 6, except that cooling to Tg or lower was carried out after the stretching zone without providing the heat treatment zone. The haze of the obtained stretched film was 0.2%, MIT in the longitudinal direction was 500 times, MIT in the transverse direction was 500 times, and burr at the end surfaces of the dumbbell in the stamping test was observed at several tens of places.

### Object of Comparative Examples 8 to 10

An object of Comparative Examples 8 to 10 below is to demonstrate that remarkable effects that burr at end surfaces of a film at the time of cutting the film is less likely to occur are achieved by a method for producing an optical film, the method fulfilling both Requirement 1 that the relaxation step is performed by carrying out a heat treatment to the stretched film and Requirement 2 that, in the relaxation step, the reducing the size of the stretched film is performed by simultaneously decreasing the sizes in the longitudinal and width directions of the stretched film.

### Comparative Example 8, Fulfilling Requirement 1, but not Fulfilling Requirement 2

A 40 μm-thick biaxially stretched film was obtained in the same manner as in Example 1, except that cooling to Tg or lower was carried out after the heat treatment was performed at 135° C. without any enlarge or reduce change in the heat treatment zone. The haze of the obtained stretched film was 0.4%, MIT in the longitudinal direction was 3,000 times, MIT in the transverse direction was 3,000 times, and burr at the end surfaces of the dumbbell in the stamping test was observed at several places.

### Comparative Example 9, Fulfilling Requirement 1, but not Fulfilling Requirement 2

A 40 μm-thick biaxially stretched film was obtained in the same manner as in Example 1, except that, in the heat treatment zone, the resultant stretched film was relaxed by 5% only in the longitudinal direction (that is, the size was reduced by 5% only in the longitudinal direction). The haze of the obtained stretched film was 0.4%, MIT in the longitudinal direction was 2,000 times, MIT in the transverse direction was 2,500 times, and burr at the end surfaces of the dumbbell in the stamping test was observed at several places.

### Comparative Example 10, Fulfilling Neither Requirement 1 nor Requirement 2

A 40 μm-thick biaxially stretched film was obtained in the same manner as in Example 1, except that the heat treatment temperature was changed to 117° C. (Tg −5° C.). The haze of the obtained stretched film was 1.8%, MIT in the longitudinal direction was 3,000 times, MIT in the transverse direction was 3,000 times, and burr at the end surfaces of the dumbbell in the stamping test was observed at several places.

Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

TABLE 1

| | Example | | | Comparative Example | | | |
|---|---|---|---|---|---|---|---|
| | 1 | 2 | 3 | 1 | 2 | 3 | 4 |
| Rubber | Present | Present | Present | Present | Present | Present | Present |
| Stretching | Simultaneous | Simultaneous | Simultaneous | Simultaneous | Simultaneous | Simultaneous | Simultaneous |
| | biaxial | biaxial | biaxial | biaxial | biaxial | biaxial | biaxial |
| Stretching | Tg + 10 | Tg + 10 | Tg + 3 | Tg + 10 | Tg + 10 | Tg + 23 | Tg + 3 |
| temperature | | | | | | | |
| (° C.) | | | | | | | |
| Heat | Tg + 13 | Tg + 10 | Tg + 23 | Without heat | Tg + 33 | Tg + 23 | Tg |
| treatment | | | | treatment | | | |
| temperature | | | | | | | |
| (° C.) | | | | | | | |
| Size | Simultaneous | Simultaneous | Simultaneous | Without | Simultaneous | Simultaneous | Simultaneous |
| reducing | longitudinal | longitudinal | longitudinal | size | longitudinal | longitudinal | longitudinal |
| | and | and | and | reducing | and | and | and |
| | transverse | transverse | transverse | | transverse | transverse | transverse |
| | 5% | 5% | 5% | | 5% | 5% | 5% |
| Haze | 0.5 | 0.7 | 0.4 | 1.8 | Film | 0.4 | 2.1 |
| (%) | | | | | broken | | |
| Longitudinal | 2500 | 2900 | 2000 | 3000 | | 1000 | 2900 |
| MIT | | | | | | | |
| (times) | | | | | | | |
| Transverse | 2500 | 2900 | 2000 | 3000 | | 1000 | 2900 |
| MIT | | | | | | | |
| (times) | | | | | | | |
| Ratio of | 1.00 | 1.00 | 1.00 | 1.00 | | 1.00 | 1.00 |
| MITs | | | | | | | |
| (Longitudinal/ | | | | | | | |
| Transverse) | | | | | | | |
| Burr | Absent | Absent | Absent | Several | | Several | Absent |
| | | | | places | | places | |

| | Comparative Example | | | | | |
|---|---|---|---|---|---|---|
| | 5 | 6 | 7 | 8 | 9 | 10 |
| Rubber | Present | Absent | Absent | Present | Present | Present |
| Stretching | Successive | Simultaneous | Simultaneous | Simultaneous | Simultaneous | Simultaneous |
| | | biaxial | biaxial | biaxial | biaxial | biaxial |
| Stretching | Tg + 23 | Tg + 10 | Tg + 10 | Tg + 10 | Tg + 10 | Tg + 10 |
| temperature | | | | | | |
| (° C.) | | | | | | |
| Heat | Tg or | Tg + 13 | Tg or | Tg + 13 | Tg + 13 | Tg − 5 |
| treatment | lower | | lower | | | |
| temperature | | | | | | |
| (° C.) | | | | | | |
| Size | Without | Simultaneous | Without | Without | Longitudinal | Simultaneous |
| reducing | size | longitudinal | size | size | only | longitudinal |
| | reducing | and | reducing | reducing | 5% | and |
| | | transverse | | | | transverse |
| | | 5% | | | | 5% |
| Haze | 1.1 | 0.2 | 0.2 | 0.4 | 0.4 | 1.8 |
| (%) | | | | | | |
| Longitudinal | 1200 | 400 | 500 | 3000 | 2000 | 3000 |
| MIT | | | | | | |
| (times) | | | | | | |
| Transverse | 1200 | 400 | 500 | 3000 | 2500 | 3000 |
| MIT | | | | | | |
| (times) | | | | | | |
| Ratio of | 1.00 | 1.00 | 1.00 | 1.00 | 0.80 | 1.00 |
| MITs | | | | | | |
| (Longitudinal/ | | | | | | |
| Transverse) | | | | | | |
| Burr | Several | Several | Several | Several | Several | Several |
| | places | places | tens of | places | places | places |
| | | | places | | | |

What is claimed is:

1. A method for producing an optical film, comprising:
forming a stretched film by stretching a thermoplastic resin composition comprising a thermoplastic resin and rubber particles at a stretching temperature; and
heating the stretched film at a heat treatment temperature while applying a tensile force in a stretching direction of the stretched film, wherein
the stretched film is a biaxially stretched film,
the stretching temperature is from Tg to (Tg+20° C.), provided that Tg is a glass transition temperature of the stretched film,
the heating reduces a size of the stretched film in the stretching direction by simultaneously decreasing a longitudinal size and a width size of the stretched film, and
the heat treatment temperature is from (Tg+10° C.) to (Tg +23° C.)

2. The method for producing an optical film according to claim 1, wherein a stretching ratio of the stretching is 1.5 to 3.0.

3. The method for producing an optical film according to claim 1, wherein a size reduction ratio represented by a formula: (D0−D1)/D0 ×100 is 0.1 to 25%, wherein D0 is the size of the stretched film before the heating and D1 is the size of the stretched film after the heating.

4. The method for producing an optical film according to claim 1, wherein a temperature of the stretched film is maintained to be Tg or higher at least from the stretching to completion of the heating.

5. The method for producing an optical film according to claim 1, wherein the heating is performed by using a radiation heating device.

6. The method for producing an optical film according to claim 1, wherein the thermoplastic resin comprises an acrylic resin.

7. The method for producing an optical film according to claim 1, wherein the thermoplastic resin comprises an acrylic resin having a glass transition temperature of 110° C. or higher.

8. The method for producing an optical film according to claim 1, wherein the thermoplastic resin comprises at least one selected from the group consisting of an acrylic resin copolymerized with an N-substituted maleimide compound as a copolymerization component, a glutaric anhydride acrylic resin, an acrylic resin having a lactone ring structure, a glutarimide acrylic resin, an acrylic resin containing a hydroxyl group and/or a carboxyl group, an aromatic vinyl-containing polymer obtained by polymerization of an aromatic vinyl monomer and another monomer copolymerizable therewith or a hydrogenated aromatic vinyl-containing polymer obtained by partial or complete hydrogenation of aromatic rings thereof, and an acrylic polymer containing a cyclic acid anhydride repeating unit.

9. The method for producing an optical film according to claim 1, wherein an orientation birefringence of the optical film is from −1.7×10⁻⁴ to 1.7×10⁻⁴.

10. The method for producing an optical film according to claim 1, wherein a photoelastic constant of the optical film is from −10×10⁻¹² to 4×10⁻¹² Pa ⁻¹.

11. An optical film, being formed from a thermoplastic resin composition comprising a thermoplastic resin and rubber particles, wherein
the optical film is a stretched film,
a ratio of MIT of the optical film in a flow direction to MIT of the optical film in a width direction is in a range of 0.7 to 1.3,
MIT of the optical film in the flow direction and MIT of the optical film in the width direction are each 1,000 times or more,
provided that MIT is the number of bending until breakage of the optical film as measured according to JIS C 5016,
a haze of the optical film as measured according to JIS K 7105 is 1.0% or less, and
in a stamping test where the optical film is punched in a dumbbell shape by using a punching machine and a circumference of the dumbbell is observed with an optical microscope, burr at end surfaces of the dumbbell is not observed.

12. An optical film, being formed from a thermoplastic resin composition comprising a thermoplastic resin and rubber particles, wherein
the optical film is a stretched film,
an average surface roughness Ra of both surfaces of the optical film at a 5 μm viewing angle is from 0.1 nm to 4 nm, and
a difference in average surface roughness between both the surfaces is 2.0 nm or less.

13. The optical film according to claim 12, wherein, in a stamping test where the optical film is punched in a dumbbell shape by using a punching machine and a circumference of the dumbbell is observed with an optical microscope, burr at end surfaces of the dumbbell is not observed.

14. The optical film according to claim 11, wherein the stretched film is a biaxially stretched film.

15. The optical film according to claim 12, wherein a haze of the optical film as measured according to JIS K 7105 is 1.0% or less.

16. The optical film according to claim 12, wherein a ratio of MIT of the optical film in a flow direction to MIT of the optical film in a width direction is in a range of 0.7 to 1.3, and MIT of the optical film in the flow direction and MIT of the optical film in the width direction are each 1,000 times or more, provided that MIT is the number of bending until breakage of the optical film as measured according to JIS C 5016.

17. The optical film according to claim 11, wherein the thermoplastic resin is an acrylic resin.

18. The optical film according to claim 11, wherein an average film thickness of the optical film is 15 to 60 μm.
